(19) United States
(12) Patent Application Publication
(10) Pub. No.: US 2006/0178470 A1
(43) Pub. Date: Aug. 10, 2006

(54) Cohesion-reduced binder production and use thereof in detachable assembly adhesives

(76) Inventors: Martin Majolo, Erkelenz (DE); Thomas Bachon, Duesseldorf (DE); Horst Beck, Neuss (DE); Dieter Oetzmann, Duesseldorf (DE); Jennifer Lambertz, Hilden (DE)

Correspondence Address: HENKEL CORPORATION, THE TRIAD, SUITE 200, 2200 RENAISSANCE BLVD., GULPH MILLS, PA, 19406, US

(21) Appl. No.: 11/396,837

(22) Filed: Apr. 3, 2006

Related U.S. Application Data
(63) Continuation of application No. PCT/EP04/10678, filed on Sep. 23, 2004.

(30) Foreign Application Priority Data
Oct. 1, 2003 (DE) 103 45 718.6

(51) Int. Cl. C08L 83/04; B32B 37/00

(52) U.S. Cl. 524/588; 524/589; 156/152

(57) ABSTRACT

Adhesive compositions containing less that 15% by weight of a binder containing a silyl-substituted polyurethane and more than 20% to 95% by weight of a filler. The compositions are useful for bonding object surfaces to inert substrate surfaces and are detachable with little to no substrate surface damage.

### CROSS REFERENCE TO RELATED APPLICATIONS

This application is a continuation under 35 U.S.C. § 365(c) and 35 U.S.C. § 120 of international application PCT/EP2004/010678, filed on Sep. 23, 2004. This application also claims priority under 35 U.S.C. § 119 of DE 103 45 718.6, which is incorporated herein by reference in its entirety.

### BACKGROUND OF THE INVENTION

This invention relates to polyurethane-containing binders with reduced cohesion, to their production and to their use in assembly adhesives. The polyurethanes present in the described binders bear silyl groups which set on exposure to moisture with an increase in molecular weight.

The use of adhesives in the DIY field is increasingly replacing mechanical fastenings and fixings, more particularly where the joint between two workpieces is only exposed to static loads or moderate repeated mechanical loads. The user associates the use of assembly adhesives above all with a form of fixing that is non-destructive in relation to the substrate on which the fixing is to be carried out. Accordingly, particular value is attributed to the “toolless”, rapid use and to the almost invisible fixing.

Assembly adhesives facilitate above all the fixing of objects to floors, walls or ceilings because the non-destructive fixing of objects makes it unnecessary, for example, to track elements for carrying electricity, gas or water under plaster at the corresponding location and thus eliminates the risk of destruction of such elements with the often high costs such damage can incur. In addition, the use of assembly adhesives considerably simplifies the fixing of objects in corners because mechanical fixing elements are often very difficult to place in corners.

Basically, therefore, the use of assembly adhesives affords a number of advantages over conventional mechanical fixing methods (nails, screws, screw/wall plug systems) which are recognized and appreciated by an increasing number of users in industry, trade and, above all, in the DIY field.

Modern assembly adhesives now have sufficiently high adhesive force to various substrates and excellent cohesion. The combination of these two factors helps in enabling even heavy objects to be fixed with assembly adhesives or bonds to be established which are even capable of permanently withstanding loads directed perpendicularly of the bonded area. Whereas the user appreciates this improvement in adhesive strength in terms of the extended fixing possibilities it offers, problems sometimes arise in regard to removal of the objects fixed with such assembly adhesives. A general observation relating to the latest generation of assembly adhesives is that, by virtue of the excellent adhesion and cohesion forces, a load applied to the bond does not result in adhesive or cohesive failure, but rather to substrate failure. Accordingly, in view of the excellent adhesion properties of modern assembly adhesives, the removal of temporarily fixed objects in particular can present serious difficulties and often results in damage to the bonded substrate.

In order to facilitate the removal of a substrate bonded with an assembly adhesive, efforts have repeatedly been made to reduce the adhesive strength (adhesion) of the assembly adhesive to such an extent that attempts to remove the substrate do not result in substrate failure, i.e. the substrate remains undamaged. However, the disadvantage of this approach is that, in view of the reduction in adhesive strength (adhesion), the strength of the bonds established with such an assembly adhesive also decreases considerably. Unfortunately, adhesive joints thus weakened no longer meet the expectations of the user in regard to the strength of the adhesive joint. In addition, adhesion varies from substrate to substrate, so that weakening of the adhesive forces overall makes the adhesive unpredictable in regard to its adhesion properties.

Accordingly, there was a need for assembly adhesives which would show excellent adhesion to a number of substrate surfaces and good cohesion. In addition, there was a need for assembly adhesives which would show excellent adhesion to a number of substrate surfaces and excellent cohesion, the bonds produced with such an assembly adhesive being readily reversible by the user without damaging the substrate or causing more damage than avoidable to the substrate.

As multipurpose plastics, polyurethanes are used in many areas of technology, above all in surface coating compositions, adhesives and sealing compounds. Polyurethanes with reactive terminal groups, particularly terminal groups capable of reacting with water, are of particular interest in this regard. This form of reactivity enables the reactive polyurethanes to be brought to the required place in the required processable form, generally liquid or highly viscous, and cured by the addition of water or other compounds reactive with the terminal groups (hardeners, for example in the case of two-component systems). The hardener is generally added before processing, the processing time available to the processor after addition of the hardener being limited.

However, polyurethanes containing reactive terminal groups may also be cured solely by reaction with atmospheric moisture, i.e. without the addition of hardeners (one-component systems). One-component systems generally have the advantage over two-component systems that the user is spared the frequently onerous task of mixing the often viscous components before use.

The polyurethanes containing reactive terminal groups commonly used in one-component and two-component systems include, for example, polyurethanes terminated by NCO groups. Given suitable functionality, polyurethanes such as these cure solely under the effect of atmospheric moisture. In certain circumstances, particularly in the presence of water (for example on moist surfaces), the use of NCO-terminated polyurethanes can be accompanied by the evolution of carbon dioxide which can have adverse affects, for example on surface structure. In addition, polyurethanes such as these often do not adhere to smooth inert surfaces, for example to surfaces of glass, ceramics, metals and the like, which in many cases necessitates the use of a primer before application of the polyurethane or makes the polyurethanes impossible to use for sealing, bonding or for sealing a surface of those materials.

In order to remedy this situation, i.e. to enable a firm and durable bond to be established between the polyurethane and, for example, the surfaces mentioned above, it has been proposed to introduce an alkoxysilane group, for example, into the polyurethane as a reactive terminal group.

EP 0 342 411 A2 describes a one-component molding and sealing compound based on prepolymers terminated by silyl groups with at least one hydrolyzable substituent at the Si atom, organometallic tin compounds as catalyst and inorganic fillers, the described mixture containing an isocyanate and/or a carboxylic acid chloride in a quantity of 0.01 to 1% by weight as stabilizer. The document in question does not contain any information on the use of the described composition as an adhesive or on the adhesion and cohesion of the described composition in the context of that use.

A general disadvantage of all moisture-curing polyurethanes or preparations (systems) containing them, but especially the silicon-containing systems, is that, after processing, the systems become brittle as a result of the curing process and, accordingly, lose a large part of their elasticity or show poor tear propagation resistances. The loss of elasticity occurs particularly frequently at low temperatures, the known systems often losing their elasticity and flexibility on cooling. Unfortunately, attempts to improve the elasticity and flexibility of the cured systems often result in a deterioration in other properties, for example greater surface tackiness, or alternatively the systems have such a high viscosity before processing that solvents, for example, have to be used to guarantee processability. A reduction in the shelf life of the systems is also observed in many cases. Both the deterioration in key material or storage properties and the use of solvents are economically and ecologically inappropriate.

WO 99/48942 describes a polyurethane obtainable by reacting at least two components, namely a polyisocyanate and a polyol. The polyol used is, for example, a polyether having a molecular weight of at least 4,000 and a polydispersity of less than 1.5.

Now, the problem addressed by the present invention was to provide a composition that would meet the requirements stated above. Another problem addressed by the present invention was to provide a composition that would not have any of the disadvantages of known compositions. More particularly, the problem addressed by the present invention was to provide a composition that would be suitable for use as an assembly adhesive, the adhesive strength of such an adhesive meeting the requirements known from the prior art and the adhesive showing particularly good redetachability (reversible-bonding behavior).

The problems stated above and other problems arising from the applications described hereinafter are solved by the compositions as further described and claimed below.

### DESCRIPTION OF THE INVENTION

Accordingly, the present invention relates to a composition at least containing a binder and a filler, characterized in that the binder present is a polyurethane containing at least one silyl group, the quantity of binder in the composition as a whole is less than 15% by weight, the quantity of fillers in the composition as a whole is more than 20 and less than 80% by weight or more than 80 to 95% by weight and the ratio by weight of filler to binder is more than about 1.44:1.

The present invention also relates to a composition at least containing a binder and a filler, characterized in that the binder present is a polyurethane containing at least one silyl group, the quantity of binder in the composition as a whole is less than 10% by weight and the quantity of fillers in the composition as a whole is more than 20 to 95% by weight.

The term “polyurethane” in the following text stands for a particular polyurethane structure which can be obtained by a controlled single-stage or multistage polyurethane synthesis. The term encompasses any deviations from this structure arising out of the statistical nature of the polyaddition process.

The term “preparation” as used in the present text stands for mixtures containing a “polyurethane” containing at least one silyl group or a mixture of two or more such “polyurethanes” as defined above, at least one filler and optionally other additives which may either be present from the polyurethane synthesis (for example solvents, catalysts) or which have been subsequently added to the polyurethane or to the mixture of two or more polyurethanes (for example plasticizers, reactive diluents, fillers and the like).

The term “binder” as used in the present text relates to the above-described polyurethane or to a mixture of two or more of the above-described polyurethanes, irrespective of whether the composition contains other polymer compounds which are reactively involved in the curing of the composition or which otherwise influence the properties of the composition. The term “binder” as used in the present text does not encompass any low molecular weight compounds which are reactively involved in the curing of the composition.

A “silyl group” in the context of the present invention is understood to be a compound corresponding to general formula I: 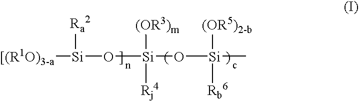
in which R¹ to R⁶ independently of one another represent a linear or branched, saturated or unsaturated hydrocarbon radical containing 1 to about 24 carbon atoms, a saturated or unsaturated cycloalkyl group containing 4 to about 24 carbon atoms or an aryl group containing 6 to about 24 carbon atoms, n, m and j are each integers of 0 to 3 (m+n+j=3), a is an integer of 0 to 3, b is an integer of 0 to 2 and c is a number of 0 to 8.

The polyurethanes containing silyl groups suitable for use in accordance with the present invention are known from the prior art. For example, the polymers described in EP 0 342 411 A2 are suitable for use as binders in accordance with the present invention. However, the polyurethanes containing silyl groups which are described in the following are preferably used for the purposes of the present invention.

For example, a polyurethane obtainable by reacting at least three components A, B and C is used in accordance with the present invention,
a) component A being a polyisocyanate or a mixture of two or more polyisocyanates and
b) component B being a polyol or a mixture of two or more polyols or a polyamine or a mixture of two or more polyamines or a mixture of a polyol and a polyamine or a mixture of two or more polyols and a polyamine or a mixture of a polyol and two or more polyamines or a mixture of two or more polyols and two or more polyamines and
c) component C being a compound corresponding to general formula II: 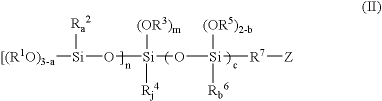
   in which R¹ to R⁶, a, b, c, n, m, and j are as defined above, R⁷ is an optionally substituted alkylene group containing 1 to about 44 carbon atoms, an optionally substituted cycloalkylene group containing 6 to about 24 carbon atoms or an optionally substituted arylene group containing 6 to about 24 carbon atoms and Z stands for NCO, NH₂, NHR¹, OH, SH or COOH. Suitable substituents are, for example, functional groups, such as thioether, mercapto, amino, ester, amido, nitro or ether groups or mixtures of two or more thereof.

However, a polyurethane obtainable by reacting at least two components B and C may also be used in accordance with the present invention,
a) component B being a polyol or a mixture of two or more polyols or a polyamine or a mixture of two or more polyamines or a mixture of a polyol and a polyamine or a mixture of two or more polyols and a polyamine or a mixture of a polyol and two or more polyamines or a mixture of two or more polyols and two or more polyamines and
b) component C being a compound corresponding to general formula II: 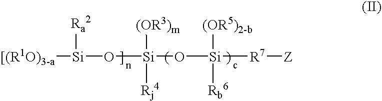
   in which R¹ to R⁶, a, b, c, n, m and j are as defined above, R⁷ is an optionally substituted alkylene group containing 1 to about 44 carbon atoms, an optionally substituted cycloalkylene group containing 6 to about 24 carbon atoms or an optionally substituted arylene group containing 6 to about 24 carbon atoms and Z stands for NCO. Again, suitable substituents are, for example, functional groups, such as thioether, mercapto, amino, ester, amido, nitro or ether groups or mixtures of two or more thereof.

According to the invention, a polyisocyanate or a mixture of two or more polyisocyanates is used as component A. Polyisocyanates in the context of the invention are understood to be compounds which contain at least two isocyanate groups (NCO groups). In general, these are compounds with the general structure O═N═C—X—C═N═O, where X is a linear or branched aliphatic, alicyclic or aromatic hydrocarbon radical which may optionally contain other inert substituents or substituents participating in the reaction.

Polyisocyanates suitable for use as component A in accordance with the invention are, for example, ethylene diisocyanate, 1,4-tetramethylene diisocyanate, 1,4-tetramethoxybutane diisocyanate, 1,6-hexamethylene diisocyanate (HDI), cyclobutane-1,3-diisocyanate, cyclohexane-1,3- and -1,4-diisocyanate, bis-(2-isocyanatoethyl)-fumarate and mixtures of two or more thereof, 1-isocyanato-3,3,5-trimethyl-5-isocyanatomethyl cyclohexane (isophorone diisocyanate, IPDI), 2,4- and 2,6-hexahydrotoluene diisocyanate, hexahydro-1,3- or -1,4-phenylene diisocyanate, benzidine diisocyanate, naphthalene-1,5-diisocyanate, 1,6-diisocyanato-2,2,4-trimethylhexane, 1,6-diisocyanato-2,4,4-trimethylhexane, xylylene diisocyanate (XDI), tetramethyl xylylene diisocyanate (TMXDI), 1,3- and 1,4-phenylene diisocyanate, 2,4- or 2,6-toluene diisocyanate (TDI), 2,4′-diphenylmethane diisocyanate, 2,2′-diphenylmethane diisocyanate or 4,4′-diphenylmethane diisocyanate (MDI) or partly or completely hydrogenated cycloalkyl derivatives thereof, for example completely hydrogenated MDI (H₁₂-MDI), alkyl-substituted diphenylmethane diisocyanates, for example mono-, di-, tri- or tetraalkyl diphenylmethane diisocyanate and partly or completely hydrogenated cycloalkyl derivatives thereof, 4,4′-diisocyanatophenyl perfluoroethane, phthalic acid-bis-isocyanatoethyl ester, 1-chloromethylphenyl-2,4- or -2,6-diisocyanate, 1-bromomethylphenyl-2,4- or -2,6-diisocyanate, 3,3-bis-chloromethylether-4,4′-diphenyl diisocyanate, sulfur-containing diisocyanates obtainable by reacting 2 mol diisocyanate with 1 mol thiodiglycol or dihydroxydihexyl sulfide, the diisocyanates and triisocyanates of dimer and trimer fatty acids or mixtures of two or more of the diisocyanates mentioned.

Other polyisocyanates suitable for use in accordance with the invention for the production of component A are isocyanates with a functionality of three or more obtainable, for example, by oligomerization of diisocyanates, more particularly by oligomerization of the isocyanates mentioned above. Examples of such tri- and higher isocyanates are the triisocyanurates of HDI or IPDI or mixtures thereof or mixed triisocyanurates thereof and polyphenyl methylene polyisocyanate obtainable by phosgenation of aniline/formaldehyde condensates.

In one particularly preferred embodiment of the present invention, TDI and MDI are used as component A.

According to the invention, component B is a polyol or a mixture of two or more polyols or a polyamine or a mixture of two or more polyamines or a mixture of a polyol and a polyamine or a mixture of two or more polyols and a polyamine or a mixture of a polyol and two or more polyamines or a mixture of two or more polyols and two or more polyamines, basically any of the polyols and polyamines typically used in polyurethane chemistry being suitable.

However, component B is preferably a polyether polyol or a polyether amine, preferably a polyether polyol, with a molecular weight (Mₙ) of at least 4,000 and a polydispersity PD (M_{w}/Mₙ) of less than 1.5 or an OH functionality of about 1.8 to 2.0 or a polydispersity PD (M_{w}/Mₙ) of less than 1.5 and an NH or OH functionality of about 1.8 to about 2.0 or a mixture of two or more such polyethers, more particularly a mixture of two or more such polyether polyols.

It has been found in accordance with the invention that, where polyethers and particularly polyether polyols such as these are used in the production of polyurethanes suitable as binders, polyurethanes with favorable material properties in the sense of the combination of excellent cohesion and adhesion according to the invention, coupled with good redetachability (reversible-bonding behaviour), can be obtained after curing.

In the context of the present invention, the term “polyol” stands for a compound which contains at least two OH groups, irrespective of whether the compound contains other functional groups. However, a polyol used in accordance with the present invention preferably contains only OH groups as functional groups or, if other functional groups are present, none of these other functional groups is reactive at least to isocyanates under the conditions prevailing during the reaction of components A and B.

In the context of the present invention, the term “polyamine” stands for a compound which contains at least two NH₂ or NHR groups, irrespective of whether the compound contains other functional groups. However, a polyamine used in accordance with the present invention preferably contains only NH₂ groups as functional groups or, if other functional groups are present, none of these other functional groups is reactive at least to isocyanates under *the conditions prevailing during the reaction of components A and B.

In one preferred embodiment, the polyethers suitable for use in component B in accordance with the present invention have a PD (M_{w}/Mₙ) of less than about 1.48. In one particularly preferred embodiment, the PD is less than about 1.45 and, most preferably, less than about 1.4. Particularly preferred polyethers have a polydispersity of about 1.01 to about 1.3 and, more particularly, in the range from about 1.05 to about 1.18, for example about 1.08 to about 1.11 or about 1.12 to about 1.14.

In another preferred embodiment of the invention, component B contains a polyether with a molecular weight (Mₙ) of at least about 4,000 and an average OH functionality (average number of OH groups per polyether molecule) of at least about 1.8 to about 2 and preferably about 1.9 to about 2.0. In one particularly preferred embodiment, the OH functionality of the polyether is about 1.93 to about 2.0 and, more particularly, about 1.95 or about 1.98 to about 2.0. In another preferred embodiment, component B consists of such a polyether or a mixture of two or more such polyethers. In other words, the functionality of component B as a whole has one of the values mentioned above.

The polyether polyols preferably to be used in accordance with the invention are obtained in known manner by catalyzed reaction of a starter compound containing at least one reactive hydrogen atom with alkylene oxides, for example ethylene oxide, propylene oxide, butylene oxide, styrene oxide, tetrahydrofuran or epichlorohydrin or mixtures of two or more thereof. In order to obtain the particularly narrow molecular weight distributions (PD) required for the purposes of the present invention, so-called DMC catalysis, for example with zinc hexacyanocobaltate, as described for example in U.S. Pat. No. 3,278,457, has proved to be particularly effective.

The polyethers used in the polyurethane according to the invention are preferably prepared using propylene oxide.

Suitable starter compounds for the production of the polyethers are, for example, water, ethylene glycol, 1,2- or 1,3-propylene glycol, 1,4- or 1,3-butylene glycol, hexane-1,6-diol, octane-1,8-diol, neopentyl glycol, 1,4-hydroxymethyl cyclohexane or 2-methylpropane-1,3-diol.

In one preferred embodiment of the invention, the polyethers have a molecular weight (Mₙ) of about 5,000 to about 30,000 and, more particularly, in the range from about 6,000 to about 20,000. Favorable results are obtained, for example, with molecular weights of about 10,000 to about 22,000 or about 11,000 to about 20,000, for example in the range from about 12,000 to about 19,000 or 13,000 to about 17,000 or about 14,000 to about 16,000 or about 15,000.

The polyols to be used in accordance with the invention have an OH value of preferably about 5 to about 15 and, more preferably, of about 10. The percentage content of primary OH groups should be below about 20%, based on all the OH groups, and is preferably below 15%. In one particularly advantageous embodiment, the acid value of the polyethers used is below about 0.1, preferably below 0.05 and, more preferably, below 0.02.

Besides the polyethers already described, component B used in accordance with the present invention may contain other polyols.

For example, component B may contain polyester polyols with a molecular weight of about 200 to about 30,000. For example, component B may contain polyester polyols obtained by reacting low molecular weight alcohols, more particularly ethylene glycol, diethylene glycol, neopentyl glycol, hexanediol, butanediol, propylene glycol, glycerol or trimethylol propane, with caprolactone. Also suitable as polyhydric alcohols for the production of polyester polyols are 1,4-hydroxymethyl cyclohexane, 2-methylpropane-1,3-diol, butane-1,2,4-triol, triethylene glycol, tetraethylene glycol, polyethylene glycol, dipropylene glycol, polypropylene glycol, dibutylene glycol and polybutylene glycol.

Other suitable polyester polyols can be obtained by polycondensation. Thus, dihydric and/or trihydric alcohols may be condensed with less than the equivalent quantity of dicarboxylic acids and/or tricarboxylic acids or reactive derivatives thereof to form polyester polyols. Suitable dicarboxylic acids are, for example, succinic acid and higher homologs thereof containing up to 16 carbon atoms, unsaturated dicarboxylic acids, such as maleic acid or fumaric acid, and aromatic dicarboxylic acids, particularly the isomeric phthalic acids, such as phthalic acid, isophthalic acid or terephthalic acid. Suitable tricarboxylic acids are, for example, citric acid or trimellitic acid. Polyester polyols of at least one of the dicarboxylic acids mentioned and glycerol which have a residual OH group content are particularly suitable for the purposes of the invention. Particularly suitable alcohols are hexanediol, ethylene glycol, diethylene glycol or neopentyl glycol or mixtures of two or more thereof. Particularly suitable acids are isophthalic acid or adipic acid and mixtures thereof.

High molecular weight polyester polyols include, for example, the reaction products of polyhydric, preferably dihydric alcohols (optionally together with small quantities of trihydric alcohols) and polybasic, preferably dibasic, carboxylic acids. Instead of free polycarboxylic acids, the corresponding polycarboxylic anhydrides or corresponding polycarboxylic acid esters with alcohols preferably containing 1 to 3 carbon atoms may also be used (where possible). The polycarboxylic acids may be aliphatic, cycloaliphatic, aromatic and/or heterocyclic. They may optionally be substituted, for example by alkyl groups, alkenyl groups, ether groups or halogens. Suitable polycarboxylic acids are, for example, succinic acid, adipic acid, suberic acid, azelaic acid, sebacic acid, phthalic acid, isophthalic acid, terephthalic acid, trimellitic acid, phthalic anhydride, tetrahydrophthalic anhydride, hexahydrophthalic anhydride, tetrachlorophthalic anhydride, endomethylene tetrahydrophthalic anhydride, glutaric anhydride, maleic acid, maleic anhydride, fumaric acid, dimer fatty acid or trimer fatty acid or mixtures of two or more thereof. Small quantities of monofunctional fatty acids may optionally be present in the reaction mixture.

Pure or mixed alkylene oxide adducts of the polyester polyols are also suitable.

Alkylene oxide adducts in the context of the present invention are the reaction products of the polyols mentioned with C₁₋₁₂ alkylene oxides, for example ethylene oxide, propylene oxide, butylene oxide, styrene oxide, tetrahydrofuran or epichlorohydrin or mixtures of two or more thereof. By “pure” alkylene oxide adducts are meant the reaction products with only one type of alkylene oxide whereas “mixed” alkylene oxide adducts are understood to be the reaction products with two or more types of alkylene oxides.

Also suitable for use in component B are, for example, polyethers which have been modified by polymers. Products such as these are obtainable, for example, by polymerizing styrene, acrylonitrile, vinyl acetate, acrylates or methacrylates or mixtures of two or more thereof in the presence of polyethers.

As already mentioned, lactone polyols and alkylene oxide adducts thereof are suitable for use in component B. Lactone polyols may be prepared, for example, by reaction of a lactone, for example ε-caprolactone, with a polyfunctional initiator, for example a polyhydric alcohol, an amine or an aminoalcohol. The reaction may optionally be carried out in the presence of an alkylene oxide or a mixture of two or more alkylene oxides.

Also suitable for use in component B are, for example, polyalkanolamines and pure or mixed alkylene oxide adducts thereof, non-reducing sugars and sugar derivatives and pure or mixed alkylene oxide adducts thereof, pure or mixed alkylene oxide adducts of aniline/formaldehyde condensates and polyphenols, isocyanate-reactive fats and fatty derivatives, for example castor oil, and pure or mixed alkylene oxide adducts thereof, vinyl polymers containing two or more OH groups and pure or mixed alkylene oxide adducts thereof.

According to the invention, therefore, component B may contain one or more polyol components although at least one polyether with a molecular weight (Mₙ) of at least 4,000 and a polydispersity PD (M_{w}/Mₙ) of less than 1.5 or an OH functionality of about 1.8 to about 2.0 or a polydispersity PD (M_{w}/Mₙ) of less than 1.5 and an OH functionality of about 1.8 to 2.0 is preferably present in component B.

In a preferred embodiment of the invention, the percentage content of this polyether or a mixture of two or more such polyethers in component B is at least about 90% by weight or preferably higher.

The OH value of component B is advantageously about 2 to about 20 and, more particularly, about 3 to about 19, for example about 4, 5, 6, 7, 8 or 9 KOH/g or about 10, 11, 12, 14, 15, 16, 17 or 18 mg KOH/g.

To produce the polyurethane usable as a binder in accordance with the invention, component A is reacted with component B under conditions typically encountered in polyurethane chemistry, generally in the presence of catalysts.

The ratio of NCO groups to OH groups is preferably adjusted so that the polyurethane containing silyl groups according to the invention has a molecular weight (Mₙ) of at least about 8,000 and preferably more than about 20,000 to about 40,000. A polyurethane molecule according to the invention may advantageously contain at least about four urethane groups.

A polyurethane according to the invention contains—laterally or terminally to the polymer backbone—a group corresponding to general formula I: 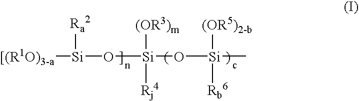
in which R¹ to R⁶ independently of one another represent a linear or branched, saturated or unsaturated hydrocarbon radical containing 1 to about 24 carbon atoms, a saturated or unsaturated cycloalkyl group containing 4 to about 24 carbon atoms or an aryl group containing 6 to about 24 carbon atoms, n, m and j are each integers of 0 to 3 (m+n+j=3), a is an integer of 0 to 3, b is an integer of 0 to 2 and c is a number of 0 to 8.

To produce the polyurethane according to the invention containing one or more of the terminal groups of general formula I mentioned above, the reaction of components A and B is carried out, for example, in the presence of a component C, component C being a compound corresponding to general formula II: 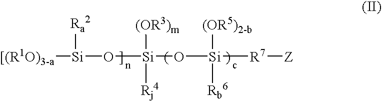
in which R¹ to R⁶, a, b, c, n, m and j are as defined above, R⁷ is an optionally substituted alkylene group containing 1 to about 44 carbon atoms, an optionally substituted cycloalkylene group containing 6 to about 24 carbon atoms or an optionally substituted arylene group containing 6 to about 24 carbon atoms and Z stands for NCO, NH₂, NHR¹, OH, SH or COOH. Suitable substituents are, for example, functional groups, such as thioether, mercapto, amino, ester, amido, nitro or ether groups or mixtures of two or more thereof.

However, components A and B may also be initially reacted with one another to form a prepolymer so that an adequate number of terminal NCO groups is formed and the prepolymer thus obtained may subsequently be reacted with component C. In this case, component C can contain only one compound corresponding to general formula II although it can equally well contain a mixture of two or more compounds corresponding to general formula II.

In addition, the polyurethane according to the invention containing one or more of the terminal groups of general formula I mentioned above can be produced by reacting components B and C, component C being a compound corresponding to general formula II: 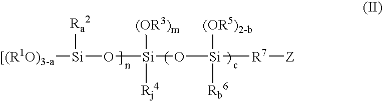
in which R¹ to R⁶, a, b, c, n, m and j are as defined above, R⁷ is an optionally substituted alkylene group containing 1 to about 44 carbon atoms, an optionally substituted cycloalkylene group containing 6 to about 24 carbon atoms or an optionally substituted arylene group containing 6 to about 24 carbon atoms and Z stands for NCO. Suitable substituents are, for example, functional groups, such as thioether, mercapto, amino, ester, amido, nitro or ether groups or mixtures of two or more thereof.

In a preferred embodiment of the present invention, compounds corresponding to general formula III, in which Z is an amino group or an isocyanate group (NCO group), are used as at least one reactant. Compounds such as are also referred to herein as aminosilanes or isocyanatosilanes.

Suitable aminosilanes are, for example, N-(α-methyldimethoxysilylmethyl)amine, N-(α-trimethoxysilylmethyl)amine, N-(α-diethylmethoxysilylmethyl)amine, N-(α-ethyldimethoxysilylmethyl)amine, N-(α-methyldiethoxysilylmethyl)amine, N-(α-triethoxysilylmethyl)amine, N-(αa-ethyldiethoxysilylmethyl)amine, N-(β-methyldimethoxysilylethyl)amine, N-(β-trimethoxysilylethyl)amine, N-(β-ethyldimethoxysilylethyl)amine, N-(β-methyldiethoxysilylethyl)amine, N-(β-triethoxysilylethyl)amine, N-(β-ethyldiethoxysilylethyl)amine, N-(γ-methyldimethoxysilylpropyl)amine, N-(γ-trimethoxysilylpropyl)amine, N-(γ-ethyldimethoxysilylpropyl)amine, N-(γ-methyldiethoxysilylpropyl)amine, N-(γ-triethoxysilylpropyl)amine, N-(γ-ethyldiethoxysilylpropyl)amine, N-(4-methyldimethoxysilylbutyl)amine, N-(4-trimethoxysilylbutyl)amine, N-(4-triethylsilylbutyl)amine, N-(4-diethylmethoxysilylbutyl)amine, N-(4-ethyldimethoxysilylbutyl)amine, N-(4-methyldiethoxysilylbutyl)amine, N-(4-triethoxysilylbutyl)amine, N-(4-diethylethoxysilylbutyl)amine, N-(4-ethyldiethoxysilylbutyl)amine, N-(5-methyldimethoxysilylpentyl)amine, N-(5-trimethoxysilylpentyl)amine, N-(5-triethylsilylpentyl)amine, N-(5-ethyldimethoxysilylpentyl)amine, N-(5-methyldiethoxysilylpentyl)amine, N-(5-triethoxysilylpentyl)amine, N-(5-diethylethoxysilylpentyl)amine, N-(5-ethyldiethoxysilylpentyl)amine, N-(6-methyldimethoxysilylhexyl)amine, N-(6-trimethoxysilylhexyl)amine, N-(6-ethyldimethoxysilylhexyl)amine, N-(6-methyldiethoxysilylhexyl)amine, N-(6-triethoxysilylhexyl)amine, N-(6-ethyldiethoxysilylhexyl)amine, N-[γ-tris-(trimethoxysiloxy)silylpropyl]amine, N-[γ-tris(trimethoxysiloxy)silylpropyl]amine, N-(γ-trimethoxysiloxydimethylsilylpropyl)amine, N-(γ-trimethylsiloxydimethoxysilylpropyl)amine, N-(γ-triethoxysiloxydiethylpropyl)amine, N-(γ-triethoxysiloxydiethoxysilylpropyl)amine, N,N-butyl-(γ-trimethoxysilylpropyl)amine, N,N-butyl-(γ-triethoxysilylpropyl)amine, N,N-phenyl-(γ-trimethoxysilylpropyl)amine, N,N-phenyl-(γ-triethoxysilylpropyl)amine, N,N-cyclohexyl-(γ-trimethoxysilylpropyl)amine, N,N-ethyl-(γ-trimethoxysilylpropyl)amine, diethyl-N-(trimethoxysilylpropyl)aspartate, diethyl-N-(triethoxysilylpropyl)aspartate, N,N-ethyl-(γ-dimethoxymethylsilylpropyl)amine, N,N-ethyl-(γ-trimethoxysilylisobutyl)-amine, N,N-bis-(trimethoxypropyl)-amine, N,N-ethyl-(γ-trimethoxysilylisobutyl)amine, N,N-ethyl-(α-trimethoxysilylmethyl)-amine, dibutyl-N-(trimethoxysilylpropyl)aspartate, dibutyl-N-(triethoxysilylpropyl)aspartate, N,N-(β-aminopropyl)-(γ-trimethoxy-silylpropyl)amine, N,N′-di-(trimethoxysilylpropyl)ethylenediamine, tetra-(trimethoxysilylpropyl)ethylenediamine and N,N-ethyl-(β-trimethoxysilylethyl)amine or N-[γ-tris(trimethylsiloxy)silylpropyl]amine or N,N-cyclohexyl-α-triethoxysilylmethylamine or N,N-cyclohexyl-α-methyldiethoxysilylmethylamine or N,N-phenyl-α-trimethoxysilylmethylamine or N,N-phenyl-α-methyldimethoxysilylmethylamine or mixtures of two or more thereof.

Suitable isocyanatosilanes are, for example, methyldimethoxysilylmethyl isocyanate, trimethoxysilylmethyl isocyanate, diethylmethoxysilylmethyl isocyanate, ethyldimethoxysilylmethyl isocyanate, methyldiethoxysilylmethyl isocyanate, triethoxysilylmethyl isocyanate, ethyldiethoxysilylmethyl isocyanate, methyldimethoxysilylethyl isocyanate, trimethoxysilylethyl isocyanate, ethyldimethoxysilylethyl isocyanate, methyldiethoxysilylethyl isocyanate, triethoxysilylethyl isocyanate, ethyldiethoxysilylethyl isocyanate, methyldimethoxysilylpropyl isocyanate, trimethoxysilylpropyl isocyanate, ethyldimethoxysilylpropyl isocyanate, methyldiethoxysilylpropyl isocyanate, triethoxysilylpropyl isocyanate, ethyldiethoxysilylpropyl isocyanate, methyldimethoxysilylbutyl isocyanate, trimethoxysilylbutyl isocyanate, triethylsilylbutyl isocyanate, diethylmethoxysilylbutyl isocyanate, ethyldimethoxysilylbutyl isocyanate, methyldiethoxysilylbutyl isocyanate, triethoxysilylbutyl isocyanate, diethylethoxysilylbutyl isocyanate, ethyldiethoxysilylbutyl isocyanate, methyldimethoxysilylpentyl isocyanate, trimethoxysilylpentyl isocyanate, triethylsilylpentyl isocyanate, ethyldimethoxysilylpentyl isocyanate, methyldiethoxysilylpentyl isocyanate, triethoxysilylpentyl isocyanate, diethylethoxysilylpentyl isocyanate, ethyldiethoxysilylpentyl isocyanate, methyldimethoxysilylhexyl isocyanate, trimethoxysilylhexyl isocyanate, ethyldimethoxysilylhexyl isocyanate, methyldiethoxysilylhexyl isocyanate, triethoxysilylhexyl isocyanate, ethyldiethoxysilylhexyl isocyanate, γ-trimethoxysiloxydimethylsilylpropyl isocyanate, trimethylsiloxydimethoxysilylpropyl isocyanate, γ-triethoxysiloxydiethylpropyl isocyanate, γ-triethoxysiloxydiethoxysilylpropyl isocyanate or mixtures of two or more thereof.

In addition, aminosilanes or isocyanatosilanes corresponding to general formula II in which the recurring unit characterized by the parameter c is a recurring unit corresponding to general formula III: 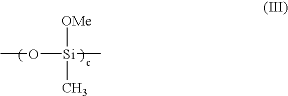
where c has a value of 1 to about 6, may also be used in accordance with the invention.

Compounds containing at least one methoxy group or one ethoxy group at the silicon atom are preferably used, compounds containing two or three methoxy groups or two or three ethoxy groups or mixtures of methoxy and ethoxy groups being particularly preferred.

In one particular embodiment of the invention, 3-aminopropyl trimethoxysilane, 3-aminopropyl dimethoxymethyl silane, 3-aminopropyl triethoxysilane, 3-aminopropyl dimethoxyphenyl silane and 3-aminopropyl diethoxyethyl silane are used.

In one preferred embodiment of the invention, component C is used in such a quantity that its percentage content in the polyurethane containing silyl groups according to the invention is less than about 3% by weight and, more particularly, about 0.5 to about 2.5% by weight, for example about 1.8 to about 2.2% by weight.

The polyurethane according to the invention may be produced both by a single-stage process and by a multistage process. In the single-stage process, all the starting materials are first mixed in the presence of an organic solvent at a water content of less than about 0.5% by weight. The mixture is heated for about 1 to about 30 hours and, more particularly, for about 2 to about 4 hours to a temperature of about 80 to about 200° C. and, more particularly, to a temperature of about 100 to about 140° C. The reaction time may optionally be shortened by addition of catalysts or the reaction temperature may be reduced. Suitable catalysts are, for example, tertiary amines such as, for example, triethyl amine, dimethyl benzyl amine, bis-dimethyl aminoethyl ether and bis-methyl aminomethyl phenol. Other particularly suitable catalysts are, for example, 1-methyl imidazole, 1-methyl-1-vinyl imidazole, 1-allyl imidazole, 1-phenyl imidazole, 1,2,4,5-tetramethyl imidazole, 1-(3-aminopropyl)-imidazole, pyrimidazole, 4-dimethyl aminopyridine (DMAP), 4-pyrrolidinopyridine, 4-morpholinopyridine and 4-methyl pyridine. Other suitable catalysts are, for example, organometallic compounds, such as iron, titanium or tin compounds, more particularly the 1,3-dicarbonyl compounds of iron or divalent or tetravalent tin, more particularly Sn(II) carboxylates and dialkyl Sn(IV) dicarboxylates or the corresponding dialkoxylates, for example dibutyl tin dilaurate, dibutyl tin diacetate, dioctyl tin diacetate, dibutyl tin maleate, tin(II) octoate, tin(II) phenolate and the acetyl acetonates of divalent and tetravalent tin.

However, the reaction is preferably carried out in the absence of a catalyst and optionally in the absence of solvent.

The multistage process is advantageously used above all in cases where component C is used in the production of the polymer according to the invention. In this case, an NCO-terminated prepolymer is initially prepared from components A and B in a suitable stoichiometric ratio by the process described above and is reacted with component C in a second stage.

The prepolymer is then reacted with component C at 50 to 120° C. in such a way that all or some of the NCO groups react with component C.

The polyurethane containing silyl groups according to the invention has a viscosity of, for example, about 10,000 to about 300,000 mPas (Brookfield RVT, 23° C., spindle 7, 2.5 r.p.m.).

The preparation according to the invention may contain up to about 20 to less than 80% by weight of fillers. Suitable fillers are, for example, inorganic compounds compatible with isocyanates and silanes, such as chalk, lime flour, kaolin, talcum, barium sulfate, mica, precipitated silica, pyrogenic silica, zeolites, bentonites, ground minerals, glass beads, glass powder, hollow glass beads glass fibers and chopped strands and other inorganic fillers known to the expert and also organic fillers, more particularly short-staple fibers or hollow plastic beads. Fillers which make the preparation thixotropic, for example swellable plastics, such as PVC, polyamide powder or polyamide waxes, may also be used.

The percentage content of fillers in the composition according to the invention is preferably more than about 25 and, more particularly, more than about 30% by weight. Particularly suitable compositions contain, for example, about 35 to less than about 80, more particularly about 40 to about 70, for example about 45 to about 65 or about 50 to about 60% by weight fillers. Other suitable compositions contain, for example, more than 80 to about 95, more particularly about 82 to about 93, for example about 85 to about 90% by weight fillers. If the percentage binder content is less than 10% by weight, it is also possible in accordance with the invention to use a percentage filler content of 20 to about 95% by weight.

In another advantageous embodiment, the binders present in a composition according to the invention and the fillers present in the composition according to the invention are in a certain ratio to one another. For example, the filler-to-binder ratio is advantageously at least about 1.44:1 or at least about 1.448:1. In a particularly advantageous embodiment, the ratio is about 1.5:1 to less than about 15:1 or about 1.6:1 to less than about 10:1, for example about 2:1 to about 8:1 or less than about 8:1 or about 3:1 to about 7:1 or about 4:1 to about 6.5:1.

The polyurethane containing silyl groups according to the invention may be put to its final use in the form hitherto described in connection with the adhesives according to the invention together with a suitable filler. In general, however, the polyurethane according to the invention is advantageously used in a preparation which contains other compounds, for example for adjusting viscosity or the properties of the material.

For example, the viscosity of the polyurethane according to the invention may be too high for certain applications. However, it has been found that the viscosity of the polyurethane according to the invention can generally be reduced in a simple and practical manner by using a “reactive diluent” without any significant adverse effect on the properties of the cured polyurethane.

Accordingly, the present invention also relates to a preparation containing a first polyurethane according to the invention as described in the foregoing and at least a second polyurethane containing at least one terminal group reactive to water, more particularly an NCO group or an alkoxysilane group or both, of which the molecular weight (Mₙ) is at most 10,000 and is lower by at least 3,000 and preferably by at least 5,000 than the molecular weight of the first polyurethane as a reactive diluent.

The reactive diluent preferably contains at least one functional group which is capable under the influence of moisture of entering into a chain-extending or crosslinking reaction with a reactive group of the first polyurethane according to the invention (reactive diluent). The at least one functional group may be any functional group capable of reacting by crosslinking or chain extension under the influence of moisture.

Suitable reactive diluents are any polymeric compounds which are miscible with the first polyurethane according to the invention and reduce its viscosity and which have hardly any effect on the material properties of the product formed after curing or crosslinking or at least do not adversely affect them to such an extent that the product becomes unusable. Suitable reactive diluents are, for example, polyesters, polyethers, polymers of compounds containing an olefinically unsaturated double bond or polyurethanes providing the requirements mentioned above are satisfied.

However, the reactive diluents are preferably polyurethanes containing at least one alkoxysilane group as reactive group.

The reactive diluents may contain one or more functional groups although the number of functional groups is preferably between 1 and about 6 and more preferably between about 2 and about 4, for example about 3.

In one preferred embodiment, the viscosity of the reactive diluents is below about 20,000 mPas and, more particularly, in the range from about 1,000 to about 10,000, for example about 3,000 to about 6,000 mPas (Brookfield RVT, 23° C., spindle 7, 2.5 r.p.m.).

The reactive diluents suitable for use in the process according to the invention may have any molecular weight distribution (PD) and, accordingly, can be produced by any of the methods typically used in polymer chemistry.

Polyurethanes which can be produced from a polyol component and an isocyanate component, followed by functionalization with one or more alkoxysilyl groups, are preferably used as the reactive diluents.

In the context of the present invention, the term “polyol component” encompasses an individual polyol or a mixture of two or more polyols which may be used for the production of polyurethanes. A polyol is understood to be a polyhydric alcohol, i.e. a compound containing more than one OH group in the molecule.

A number of polyols may be used as the polyol component for producing the reactive diluent. They include, for example, aliphatic alcohols containing 2 to 4 OH groups per molecule. The OH groups may be both primary and secondary. Suitable aliphatic alcohols include, for example, ethylene glycol, propylene glycol and the same polyhydric alcohols as have already been mentioned in the present specification.

Polyethers which have been modified by vinyl polymers are also suitable for use as the polyol component. Products such as these are obtainable, for example, by polymerizing styrene and/or acrylonitrile in the presence of polyethers.

Polyester polyols with a molecular weight of about 200 to about 5,000 are also suitable as polyol component for the production of the reactive diluent. For example, polyester polyols obtainable by the above-described reaction of low molecular weight alcohols, more particularly ethylene glycol, diethylene glycol, neopentyl glycol, hexanediol, butanediol, propylene glycol, glycerol or trimethylol propane, with caprolactone may be used. As already mentioned, other polyhydric alcohols suitable for the production of polyester polyols are 1,4-hydroxymethyl cyclohexane, 2-methylpropane-1,3-diol, butane-1,2,4-triol, triethylene glycol, tetraethylene glycol, polyethylene glycol, dipropylene glycol, polypropylene glycol, dibutylene glycol and polybutylene glycol.

As described above, other suitable polyester polyols can be obtained by polycondensation. Thus, dihydric and/or trihydric alcohols can be condensed with less than the equivalent quantity of dicarboxylic acids and/or tricarboxylic acids or reactive derivatives thereof to form polyester polyols. Suitable dicarboxylic acids and tricarboxylic acids and suitable alcohols were mentioned in the foregoing.

According to the invention, polyols used with particular preference as the polyol component for producing the reactive diluents are, for example, dipropylene glycol and/or polypropylene glycol with a molecular weight of about 400 to about 2,500 and polyester polyols, preferably polyester polyols obtainable by polycondensation of hexanediol, ethylene glycol, diethylene glycol or neopentyl glycol or mixtures of two or more thereof and isophthalic acid or adipic acid or mixtures thereof.

Another suitable polyol component for producing the reactive diluents are polyacetals. Polyacetals are compounds obtainable from glycols, for example diethylene glycol or hexanediol, with formaldehyde. Polyacetals suitable for use in accordance with the present invention may also be obtained by the polymerization of cyclic acetals.

Polycarbonates are also suitable as polyols for producing the reactive diluents. Polycarbonates may be obtained, for example, by reaction of diols, such as propylene glycol, butane-1,4-diol or hexane-1,6-diol, diethylene glycol, triethylene glycol or tetraethylene glycol or mixtures of two or more thereof, with diaryl carbonates, for example, diphenyl carbonate, or phosgene.

Polyacrylates containing OH groups are also suitable as polyol component for producing the reactive diluents. These polyacrylates may be obtained, for example, by the polymerization of ethylenically unsaturated monomers containing an OH group. Such monomers are obtainable, for example, by the esterification of ethylenically unsaturated carboxylic acids and dihydric alcohols, the alcohol generally being present in a slight excess. Ethylenically unsaturated carboxylic acids suitable for this purpose are, for example, acrylic acid, methacrylic acid, crotonic acid or maleic acid. Corresponding OH-functional esters are, for example, 2-hydroxyethyl acrylate, 2-hydroxyethyl methacrylate, 2-hydroxypropyl acrylate, 2-hydroxypropyl methacrylate, 3-hydroxypropyl acrylate or 3-hydroxypropyl methacrylate or mixtures of two or more thereof.

To produce the preferred reactive diluents according to the invention, the corresponding polyol component is reacted with an at least difunctional isocyanate. Basically, the at least difunctional isocyanate used for the production of component A may be any isocyanate containing at least two isocyanate groups, although compounds containing two to four isocyanate groups and more particularly two isocyanate groups are preferred for the purposes of the invention.

The polyisocyanates mentioned above are particularly suitable for the production of the reactive diluents.

The compound present as reactive diluent in accordance with the present invention preferably contains at least one alkoxysilane group, preferred alkoxysilane groups being dialkoxy and trialkoxysilane groups.

Under certain conditions, it can be of advantage for the functional groups of the reactive diluent to differ in their reactivity to moisture or to the particular hardener used from the functional groups of the first polyurethane with the higher molecular weight. For example, it may be desirable for the reactive diluent to react more slowly than the first polyurethane in order to maintain the diluting effect for as long as possible. If the first polyurethane contains one or more terminal alkoxysilane groups, the reactivity of the terminal groups of the reactive diluent can be controlled, for example, by using other alkoxy groups than in the terminal groups of the first polyurethane. If, for example, methoxy groups are present in the terminal groups of the first polyurethane, the reactivity of the reactive diluent thereto can be reduced by using alkoxysilane groups containing alkoxy groups with two or more carbon atoms as the reactive groups. The reactivity of the reactive diluent can also be controlled to the extent that it crosslinks or cures more quickly than the first polymer and, hence, frequently contributes for example towards an improvement in shelf life. In addition, reactivity and shelf life can be influenced by varying the nature of the substituents at the Si atom. For example, silyl-terminated compounds containing 2 or 1 alkoxy groups or 1 or 2 alkyl groups may be used in accordance with the invention. In this case, reactivity decreases with the number of alkyl groups.

In one preferred embodiment of the invention, the reactive diluent contains a terminal group corresponding to general formula I, where R¹, R² and R³ are as already defined, as at least one terminal group reactive to water.

The production of the reactive diluents preferably used for the purposes of the present invention may be carried out, for example, similarly to the above-described production of the first polyurethane. A prepolymer terminated by one or more NCO groups is first prepared from the isocyanate component and the polyol component and is subsequently reacted with suitable alkoxysilanes to form the preferred reactive diluents. Suitable alkoxysilanes are, in particular, the alkoxysilanes described above which are suitable, for example, for use in component C.

The preparation according to the invention contains the first polyurethane and the reactive diluent or a mixture of two or more reactive diluents in general in such a ratio that the preparation has a viscosity of at most 200,000 mPas (Brookfield RVT, 23° C., spindle 7, 2.5 r.p.m.). A percentage content of reactive diluent (including a mixture of two or more reactive diluents), based on the preparation as a whole, of about 1% by weight to about 70% by weight and, more particularly, about 5% by weight to about 25% by weight is generally suitable for this purpose.

Instead of or in addition to a reactive diluent, a plasticizer may also be used to reduce the viscosity of the polyurethane according to the invention.

“Plasticizers” in the context of the present invention are compounds which are inert to the first polyurethane and which reduce the viscosity of a preparation containing a polyurethane according to the invention or a mixture of two or more polyurethanes according to the invention.

Suitable plasticizers are, for example, esters, such as abietic acid esters, adipic acid esters, azelaic acid esters, benzoic acid esters, butyric acid esters, acetic acid esters, esters of higher fatty acids containing about 8 to about 44 carbon atoms, esters of OH-functional or epoxidized fatty acids, fatty acid esters and fats, glycolic acid esters, phosphoric acid esters, phthalic acid esters of linear or branched C₁₋₁₂ alcohols, propionic acid esters, sebacic acid esters, sulfonic acid esters, thiobutyric acid esters, trimellitic acid esters, citric acid esters and nitrocellulose- and polyvinyl acetate-based esters and mixtures of two or more thereof. The asymmetrical esters of dibasic aliphatic dicarboxylic acids, for example the esterification product of adipic acid monooctyl ester with 2-ethylhexanol (Edenol DOA, a product of Henkel, Düsseldorf), are particularly suitable. Plasticizing alkyl sulfonic acid esters, such as phenyl alkyl sulfonic acid ester, are also suitable.

Other suitable plasticizers are the pure or mixed ethers of monohydric, linear or branched C₄₋₁₆ alcohols or mixtures of two or more different ethers of such alcohols, for example dioctyl ethers (obtainable as Cetiol OE, a product of Cognis, Düsseldorf).

In another preferred embodiment, end-capped polyethylene glycols, for example polyethylene or polypropylene glycol di-C₁₋₁₀-alkyl ethers, more particularly the dimethyl or diethyl ether of diethylene glycol or dipropylene glycol, and mixtures of two or more thereof, are used as plasticizers.

According to the invention, diurethanes are also suitable plasticizers. Diurethanes may be obtained, for example, by reaction of OH-terminated diols with monofunctional isocyanates, the stoichiometry being selected so that substantially all free OH groups react off. Any excess isocyanate may then be removed from the reaction mixture, for example by distillation. Another method of producing diurethanes comprises reacting monohydric alcohols with diisocyanates, all the NCO groups reacting off.

To produce the diurethanes based on diols, diols containing 2 to about 22 carbon atoms may be used. Examples of such diols include ethylene glycol, propylene glycol, propane-1,2-diol, dibutanediol, hexanediol, octanediol or technical mixtures of hydroxyfatty alcohols containing about 14 carbon atoms, more particularly hydroxystearyl alcohol. Linear diol mixtures, particularly those containing polypropylene glycol with an average molecular weight (Mₙ) of about 1,000 to about 6,000 in quantities of more than about 50% by weight and, more particularly, more than about 70% by weight are preferred. Diurethanes based solely on propylene glycol with the same or different average molecular weights of about 1,000 to about 4,000 are most particularly preferred. Substantially all the free OH groups of the diol mixtures are reacted off with aromatic or aliphatic monoisocyanates or mixtures thereof. Preferred monoisocyanates are phenyl isocyanate or toluene isocyanate or mixtures thereof.

To produce the diurethanes based on diisocyanates, aromatic or aliphatic diisocyanates or mixtures thereof are used. Suitable aromatic or aliphatic diisocyanates are, for example, the isocyanates mentioned above as suitable for the production of the polyurethane according to the invention, preferably toluene diisocyanate (TDI). The free NCO groups of the diisocyanates are reacted substantially completely with monohydric alcohols, preferably linear monohydric alcohols or mixtures of two or more different monohydric alcohols. Mixtures of linear monohydric alcohols are particularly suitable. Suitable monoalcohols are, for example, monoalcohols containing 1 to about 24 carbon atoms, for example methanol, ethanol, the position isomers of propanol, butanol, pentanol, hexanol, heptanol, octanol, decanol or dodecanol, more particularly the respective 1-hydroxy compounds, and mixtures of two or more thereof. So-called “technical mixtures” of alcohols and end-capped polyalkylene glycol ethers are also suitable. Alcohol mixtures containing polypropylene glycol monoalkyl ethers with an average molecular weight (Mₙ) of about 200 to about 2,000 in a quantity of more than about 50% by weight and preferably more than about 70% by weight, based on the alcohol mixtures, are particularly suitable. Diurethanes based on diisocyanates of which the free NCO groups have been completely reacted with polypropylene glycol monoalkyl ethers having an average molecular weight of about 500 to about 2,000 are particularly preferred.

The preparation according to the invention generally contains the plasticizers mentioned in such a quantity that the preparation has a viscosity of at most about 700,000 mPas (Brookfield RVT, 23° C., spindle 7, 2.5 r.p.m.).

In addition, it has been found to be of advantage if the extrusion rate of a preparation according to the invention, as measured to ISO 9048 mm (4 mm diameter breaker plate, 2 bar), is about 100 to about 1,000 ml/min.

Taking into account the various polyurethanes which may be present in the preparation, different quantities of plasticizer may be necessary to achieve the stated viscosity. In general, however, the required viscosity can be achieved by adding about 1 to about 30% by weight of plasticizer, based on the preparation. Any increase in the quantity of plasticizer generally leads to a further reduction in viscosity.

The preparation according to the invention may contain the reactive diluents or the plasticizers individually or in the form of mixtures.

Besides reactive diluents and plasticizers, the preparation according to the invention may contain other additives which are generally intended to modify certain material properties of the preparation before or after processing or which promote the stability of the preparation before or after processing.

In many cases, it is appropriate to stabilize the preparations according to the invention against penetrating moisture in order to increase their shelf life. Such an improvement in shelf life can be obtained, for example, by using moisture stabilizers. Suitable moisture stabilizers are any compounds which react with water to form a group inert to the reactive groups present in the preparation, but which at the same time undergo only minimal changes in their molecular weight. In addition, the reactivity of the stabilizers to moisture which has penetrated into the preparation must be higher than the reactivity of the terminal groups of the polyurethane according to the invention present in the preparation or the mixture of two or more such polyurethanes.

Suitable moisture stabilizers are, for example, isocyanates.

In one preferred embodiment, however, the moisture stabilizers used are silanes, for example vinyl silanes, such as 3-vinylpropyl triethoxysilane, oxime silanes, such as methyl-O,O′,O″-butan-2-one trioxime silane or O,O′,)″,)′″-butan-2-one tetraoxime silane (CAS No. 022984-54-9 and 034206-40-1), or benzamidosilanes, such as bis-(N-methylbenzamido)-methyl ethoxysilane (CAS No. 16230-35-6).

Other moisture stabilizers are the above-mentioned reactive diluents providing they have a molecular weight (Mₙ) of less than about 5,000 and contain terminal groups of which the reactivity to moisture which has penetrated into the preparation is at least as high as and preferably higher than the reactivity of the reactive groups of the polyurethane according to the invention.

The preparation according to the invention generally contains about 0 to about 6% by weight of moisture stabilizers.

The preparation according to the invention may additionally contain up to about 7% by weight and, more particularly, about 3 to about 5% by weight of antioxidants.

The preparation according to the invention may additionally contain up to about 5% by weight of catalysts to control the cure rate. Suitable catalysts are, for example, organometallic compounds, such as iron or tin compounds, more particularly the 1,3-dicarbonyl compounds of iron or divalent or tetravalent tin, more particularly Sn(II) carboxylates or dialkyl Sn(IV) dicarboxylates and the corresponding dialkoxylates, for example dibutyl tin dilaurate, dibutyl tin diacetate, dioctyl tin diacetate, dibutyl tin maleate, tin(II) octoate, tin(II) phenolate or the acetyl acetonates of divalent or tetravalent tin. Other suitable catalysts are the above-mentioned amines, which may be used in the actual production of the polyurethane according to the invention, and also titanates or zirconates.

If it is to be used as an adhesive, the preparation according to the invention may contain up to about 30% by weight of typical tackifiers. Suitable tackifiers are, for example, resins, terpene oligomers, couramone/indene resins, aliphatic petrochemical resins and modified phenolic resins.

The preparation according to the invention may contain up to about 2% by weight and preferably about 1% by weight of UV stabilizers. Particularly suitable UV stabilizers are the so-called hindered amine light stabilizers (HALS). A preferred embodiment of the present invention is characterized by the use of a UV stabilizer which contains a silane group and which is incorporated in the end product during crosslinking or curing. The products Lowilite 75 and Lowilite 77 (Great Lakes, USA) are particularly suitable for this purpose.

The present invention also relates to a preparation containing

about 1% by weight to about 15% by weight of a binder,

about 20% by weight to 95% by weight, for example 20 to less than 80 or more than 80 to about 95% by weight of a filler or a mixture of two or more fillers,

about 0% by weight to about 70% by weight of a reactive diluent or a mixture of two or more reactive diluents,

about 0% by weight to about 30% by weight of a plasticizer or a mixture of two or more plasticizers,

about 0% by weight to about 5% by weight of a moisture stabilizer or a mixture of two or more moisture stabilizers,

about 0% by weight to about 30% by weight of a tackifier or a mixture of two or more tackifiers,

about 0% by weight to about 5% by weight of a UV stabilizer or a mixture of two or more UV stabilizers and

about 0% by weight to about 5% by weight of a catalyst or a mixture of two or more catalysts.

In principle, the preparations according to the invention may be produced by any processes known to the expert. Accordingly, the present invention also relates to a process for the production of a composition according to the invention, in which at least one binder and at least one filler are mixed together, the binder present being a polyurethane containing at least one silyl group, the quantity of binder in the composition as a whole being less than about 15% by weight, the quantity of fillers in the composition as a whole being more than 20 and less than 80% by weight and the ratio by weight of filler to binder being more than about 1.44:1.

The present invention also relates to a process for the production of a composition according to the invention, in which at least one binder and at least one filler are mixed together, the binder present being a polyurethane containing at least one silyl group, the quantity of binder in the composition as a whole being less than 10% by weight and the quantity of fillers in the composition as a whole being more than 20 to 95% by weight.

In a preferred embodiment, the percentage filler content is more than 25% by weight or the filler-to-binder ratio is about 1.5:1 to less than 8:1 or the percentage filler content is more than 25% by weight and the filler-to-binder ratio is about 1.5:1 to less than 8:1.

The polyurethanes according to the invention and the preparations according to the invention are suitable for a broad range of applications in the adhesives field. The preparations according to the invention are particularly suitable, for example, as a contact adhesive, a one-component adhesive, a two-component adhesive or an assembly adhesive. Accordingly, the present invention also relates to the use of a composition according to the invention as a contact adhesive, a one-component adhesive, a two-component adhesive or an assembly adhesive.

The preparations according to the invention are suitable, for example, as adhesives for plastics, metals, mirrors, glass, ceramics, mineral substrates, wood, leather, textiles, paper, cardboard and rubber, the materials being bondable to materials of the same type or to materials of different types.

For all the applications mentioned above, the preparations according to the invention may be used as one-component, i.e. moisture-curing, systems or as two-component systems, the second component containing water for example.

By virtue of their particular binder-to-filler ratio, the compositions used in accordance with the invention have excellent adhesion and cohesion for most applications although, at the same time, the removability of a workpiece bonded with such a composition is improved in an unforeseeable manner. In practice, this is reflected in the fact that a workpiece bonded with a composition according to the invention can be cut with a sharp object at the adhesive joint formed with the adhesive while a pull is exerted substantially perpendicularly of the bond plane during the cutting process. By virtue of the particular proportions of the individual components in the composition according to the invention, the workpieces thus bonded can be removed from a corresponding substrate with only moderate force.

Basically, the bond can be cut with any suitably dimensioned tools, for example with putty knives, grouting knives, Ceran hob scrapers, wooden putty knives, trowels, plastic putty knives, flexible putty knives, Japanese putty knives, drawing wires and the like.

The workpiece to be removed is preferably raised slightly so that the tool used for cutting can be applied more easily to the bond. The tool is then inserted into the gap thus formed and a cut is made into the layer of adhesive while a pull is continuously applied to the workpiece. Surprisingly, despite the excellent adhesive strength, the workpiece can be separated from the substrate by gentle force after only a single cut into the bond.

Residues of adhesive on porous substrates and workpieces can be removed, for example, with a putty knife. On smooth substrates, (glazed tiles, glass, mirrors, Resopal and the like), the adhesive can easily be removed with a Ceran hob scraper.

Streaks can readily be removed with a suitable cleaner, for example with Sidolin or Pril (both products of Henkel KGaA, Düsseldorf).

Workpieces which have been removed can put back using the same adhesive. In this case, the adhesive does not have to be completely removed from the workpiece. Residues of adhesive on porous substrates can be sanded or coated over, for example.

Accordingly, the present invention also relates to the use of a composition at least containing a binder and a filler, characterized in that the binder present is a polyurethane containing at least one silyl group, the quantity of binder in the composition as a whole is less than about 15% by weight, the quantity of fillers in the composition as a whole is more than 20 and less than 80% by weight or more than about 80 to about 95% by weight and the ratio by weight of filler to binder is more than about 1.44:1, as a redetachable (reversible-bonding) adhesive.

The present invention also relates to a process for the reversible bonding of at least one object and at least one substrate, in which at least one substrate surface or at least one object surface or at least one substrate surface and at least one object surface is/are coated with a composition according to the invention or with a composition produced by a process according to the invention and the coated substrate surface is brought into contact with a coated or uncoated object surface or the coated object surface is brought into contact with a coated or uncoated substrate surface.

As used herein, and in particular as used herein to define the elements of the claims that follow, the articles “a” and “an” are synonymous and used interchangeably with “at least one” or “one or more,” disclosing or encompassing both the singular and the plural, unless specifically defined otherwise. The conjunction “or” is used herein in its inclusive disjunctive sense, such that phrases formed by terms conjoined by “or” disclose or encompass each term alone as well as any combination of terms so conjoined, unless specifically defined otherwise. All numerical quantities are understood to be modified by the word “about,” unless specifically modified otherwise or unless an exact amount is needed to define the invention over the prior art.

The following Examples are intended to illustrate the invention.

1. Formulation according to the invention with a reduced binder
content and an adjusted binder-to-filler ratio
All quantities in % by weight

| | | |
|---|---|---|
| 1. | Prepolymer (PPG M_{w} 18,000 + γ-isocyanatopropyl | 9 |
| | trimethoxysilane) | |
| 2. | Chalk | 55 |
| 3. | Thickener (Rilanit micro, Cognis) | 5 |
| 4. | Plasticizer (C₁₀₋₂₁ alkylphenol sulfonic acid ester) | 28 |
| 5. | Dibutyl tin dilaurate | 0.03 |
| 6. | Coupling agent (vinyl trimethoxysilane) | 2 |
| 7. | Coupling agent (diaminotrimethoxysilane) | 0.97 |

Technical data

| Breaking elongation | 70% | |
|---|---|---|
| Tensile shear strength (DIN EN 205 A wood/wood) | 2.7 | N/mm² |
| Drawing wire (steel, twisted with 3 individual wires, | 9 | N/mm |
| diameter 0.85 mm) | | |
| Skinning (23° C., 50% relative humidity) | 15 | mins. |
| Processability (ISO 9048) | 500 | g/min |
| Density (Erichsen cup) | 1.8 | g/cm³ |

2. Comparison formulation
All quantities in % by weight

| | | |
|---|---|---|
| 1. | Prepolymer (PPG M_{w} 18,000 + γ-isocyanatopropyl | 27 |
| | trimethoxysilane) | |
| 2. | Chalk | 37 |
| 3. | Thickener (Rilanit micro, Cognis) | 5 |
| 4. | Plasticizer (Mesamoll, Bayer AG) | 28 |
| 5. | Dibutyl tin dilaurate | 0.03 |
| 6. | Coupling agent (VTMO, Witco) | 2 |
| 7. | Coupling agent (DAMO, Witco) | 0.97 |

Technical data

| Breaking elongation | 280% | |
|---|---|---|
| Tensile shear strength (DIN EN 205 A wood/wood) | 4.7 | N/mm² |
| Drawing wire (steel, twisted with 3 individual wires, | 27 | N/mm |
| diameter 0.85 mm) | | |
| Skinning (23° C., 50% relative humidity) | 20 | mins. |
| Processability (ISO 9048) | 500 | g/min |
| Density (Erichsen cup) | 1.4 | g/cm³ |

In the drawing wire test, a wire with the properties shown above is applied to an adhesive joint and bent through 90° towards the bond. The force with which the wire can be drawn through the adhesive joint is then measured and expressed in N per mm width of the adhesive joint. The bond is a standard bond with a thickness of about 0.9 mm.

What is claimed is:

1. A composition comprising less than 15% by weight of a binder and more than 20 and less than 80% by weight or more than 80 to 95% by weight of a filler, wherein the binder comprises a polyurethane containing at least one silyl group and the binder and filler are present in a ratio by weight of more than about 1.44:1.

2. A composition comprising less than 10% by weight of a binder and more than 20 to 95% by weight of a filler, wherein the binder comprises a polyurethane containing at least one silyl group.

3. The composition of claim 2, wherein the binder has a viscosity of 10,000 to 300,000 mPas (Brookfield RVT, 23° C., spindle 7, 2.5 r.p.m.).

4. The composition of claim 2, wherein the filler content is less than 25% by weight.

5. The composition of claim 1, having a weight ratio of filler to binder of 1.5:1 to less than 10:1.

6. The composition of claim 2, wherein the binder comprises a polyurethane obtainable by reacting at least three components A, B and C,
a) component A being a polyisocyanate or a mixture of two or more polyisocyanates,
b) component B being a polyol or a mixture of two or more polyols and
c) component C being a compound corresponding to general formula II: 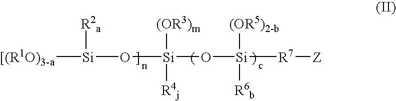
in which R¹ to R⁶ independently of one another represent a linear or branched, saturated or unsaturated hydrocarbon radical containing 1 to about 24 carbon atoms, a saturated or unsaturated cycloalkyl group containing 4 to about 24 carbon atoms or an aryl group containing 6 to about 24 carbon atoms, n, m and j are each integers of 0 to 3 (m+n+j=3), a is an integer of 0 to 3, b is an integer of 0 to 2 and c is a number of 0 to 8, R⁷ is an optionally substituted alkylene group containing 1 to about 44 carbon atoms, an optionally substituted cycloalkylene group containing 6 to about 24 carbon atoms or an optionally substituted arylene group containing 6 to about 24 carbon atoms and Z stands for NCO, NH₂, NHR¹, OH, SH or COOH.

7. The composition of claim 2, wherein the binder comprises a polyurethane obtainable by reacting at least two components B and C,
a) component B being a polyol or a mixture of two or more polyols and
b) component C being a compound corresponding to general formula II: 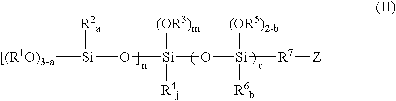
in which R¹ to R⁶ independently of one another represent a linear or branched, saturated or unsaturated hydrocarbon radical containing 1 to about 24 carbon atoms, a saturated or unsaturated cycloalkyl group containing 4 to about 24 carbon atoms or an aryl group containing 6 to about 24 carbon atoms, n, m and j are each integers of 0 to 3 (m+n+j=3), a is an integer of 0 to 3, b is an integer of 0 to 2 and c is a number of 0 to 8, R⁷ is an optionally substituted alkylene group containing 1 to about 44 carbon atoms, an optionally substituted cycloalkylene group containing 6 to about 24 carbon atoms or an optionally substituted arylene group containing 6 to about 24 carbon atoms and Z stands for NCO.

8. The composition of claim 1, comprising:
1% by weight to 15% by weight of a binder,
20 to less than 80 or more than 80 to about 95% by weight of a filler or a mixture of two or more fillers,
about 0% by weight to about 70% by weight of a reactive diluent or a mixture of two or more reactive diluents,
about 0% by weight to about 30% by weight of a plasticizer or a mixture of two or more plasticizers,
about 0% by weight to about 5% by weight of a moisture stabilizer or a mixture of two or more moisture stabilizers,
about 0% by weight to about 30% by weight of a tackifier or a mixture of two or more tackifiers,
about 0% by weight to about 5% by weight of a UV stabilizer or a mixtures of two or more UV stabilizers and
about 0% by weight to about 5% by weight of a catalyst or a mixture of two or more catalysts.

9. The composition of claim 2, comprising:
1% by weight to less than 10% by weight of a binder,
20 to 95% by weight of a filler or a mixture of two or more fillers,
about 0% by weight to about 70% by weight of a reactive diluent or a mixture of two or more reactive diluents,
about 0% by weight to about 30% by weight of a plasticizer or a mixture of two or more plasticizers,
about 0% by weight to about 5% by weight of a moisture stabilizer or a mixture of two or more moisture stabilizers,
about 0% by weight to about 30% by weight of a tackifier or a mixture of two or more tackifiers,
about 0% by weight to about 5% by weight of a UV stabilizer or a mixture of two or more UV stabilizers and
about 0% by weight to about 5% by weight of a catalyst or a mixture of two or more catalysts.

10. A process for the production of the composition of claim 1, in which at least one binder and at least one filler are mixed together, the binder present being a polyurethane containing at least one silyl group, the quantity of binder in the composition as a whole being less than about 15% by weight, the quantity of fillers in the composition as a whole being more than 20 and less than 80% by weight or more than 80 to 95% by weight and the ratio by weight of filler to binder being more than about 1.44:1.

11. A process for the production of the composition claimed of claim 2, in which at least one binder and at least one filler are mixed together, the binder present being a polyurethane containing at least one silyl group, the quantity of binder in the composition as a whole being less than 10% by weight and the quantity of fillers in the composition as a whole being more than 20 to 95% by weight.

12. The process of claim 10, wherein
the percentage filler content is more than 25% by weight or
the filler-to-binder ratio is about 1.5:1 to less than 10:1 or
the percentage filler content is more than 25% by weight and the filler-to-binder ratio is about 1.5:1 to less than 10:1.

13. The process of claim 11, wherein
the percentage filler content is more than 25% by weight or
the filler-to-binder ratio is about 1.5:1 to less than 10:1 or
the percentage filler content is more than 25% by weight and the filler-to-binder ratio is about 1.5:1 to less than 10:1.

14. A process for the reversible bonding of at least one object and at least one substrate, in which at least one substrate surface or at least one object surface or at least one substrate surface and at least one object surface is/are coated with the composition claimed of claim 1 and the coated substrate surface is brought into contact with a coated or uncoated object surface or the coated object surface is brought into contact with a coated or uncoated substrate surface.

15. A process for the reversible bonding of at least one object and at least one substrate, in which at least one substrate surface or at least one object surface or at least one substrate surface and at least one object surface is/are coated with the composition claimed of claim 2 and the coated substrate surface is brought into contact with a coated or uncoated object surface or the coated object surface is brought into contact with a coated or uncoated substrate surface.
